(19) United States
(12) Patent Application Publication
(10) Pub. No.: US 2004/0160305 A1
(43) Pub. Date: Aug. 19, 2004

(54) Electronic access control system

(76) Inventors: Michael Remenih, San Fernando, CA (US); Dale Arthur Mathias, La Guna Nigel, CA (US); Tuan A. Tran, Garden Grove, CA (US); Quang Pham, Irvine, CA (US); Dan Q. Ngo, Westminster, CA (US); Linh Justin Nguyen, Garden Grove, CA (US); Brad Gorsha, Irvine, CA (US); Roger A. Carlson, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/368,665

(22) Filed: Feb. 18, 2003

(51) Int. Cl. H04Q 1/00; G05B 19/00

(52) U.S. Cl. 340/5.22; 340/5.6; 340/5.7

(57) ABSTRACT

A security system includes an electronic lock and an electronic key. The electronic key holds identification data that notifies the lock of the key's functional type and the locks that the key is authorized to open. In one embodiment, circuitry in the lock checks whether an inserted key holds an access code that is more recent than a corresponding access code stored in the lock, indicating that the data on the inserted key is more current than the data stored in the lock. The lock is then automatically reprogrammed with the data stored in the inserted key.

### TECHNICAL FIELD

The present invention relates to security systems for controlling access into and within buildings, and more particularly to a security system incorporating electronic controls.

### BACKGROUND OF THE INVENTION

Electronic locking systems are commonly used in applications requiring door locks for a large number of individual rooms, such as hotels, offices, and multi-housing (e.g., time shares, apartments, student housing, assisted living facilities). For security purposes, the door lock of each dwelling should have a different key for successive tenants. Further, the door lock should be operable by different keys assigned to housing management, maintenance personnel, roommates, and other people requiring access to a housing unit.

Most electronic locking systems operate via a programmed key that contains a unique identification code. Each lock also contains authorization codes corresponding to one or more keys authorized to open the lock. If the identification number in the key matches the authorization codes in the lock, the lock will open. As tenants and/or personnel changes, the authorization codes in the lock are reprogrammed to accept new keys and reject old ones.

Although there are security systems for the multi-housing industry that provide electronic locking systems, these systems often have limited functionalities and are not flexible enough to accommodate the many types of access that multi-housing facilities require. Further, currently known systems still require the housing management to maintain a stock of preprogrammed keys that will later be assigned to users. Synchronization between the housing management office and the door locks also requires labor and time to reprogram the lock to accept new keys and make old keys inoperative.

There is a desire for a security system that offers a wider range of access options and flexibility than currently known security systems. There is also a desire for a locking system that can re-key locks more easily than currently known systems to ensure that information between the management office and the locks regarding key access can be synchronized easily and quickly.

### SUMMARY OF THE INVENTION

Accordingly, one embodiment of the invention is directed to an electronic access control system including a lock having a lock memory and a lock circuit that accesses the lock memory, and an electronic key having a key access code and key data stored thereon. Both the lock memory and the electronic key have corresponding access codes, and the system is designed to reprogram the lock memory if the key access code is greater than the lock access code. The invention is also directed to an electronic key for such an electronic access system as well as a stand-alone utility device that can be taken to individual locks for auditing purposes.

The invention is also directed to a method for controlling access in a property having a lock with a lock access code and lock data with an electronic key having a key access code and key. The method includes comparing the key access code with the lock access code, denying entry if the key access code is less than the lock access code, allowing entry if the key access code is equal to the lock access code, and reprogramming the lock as well as allowing entry if the key access code is greater than the lock access code. Reprogramming the lock may include replacing the lock access code stored in the lock with the key access code as well as replacing any other data stored in the lock with data stored in the key.

As a result, the inventive structure and method allows automatic lock reprogramming via an access key rather than requiring an operator to manually reprogram the lock each time the authorization for the lock needs to be changed (e.g., when a tenant moves out, when a tenant or worker loses a key, etc.). In one embodiment, new keys can be programmed at a central office. When the programmed keys are used at a unit, the key automatically reprograms the lock to lock out any previously authorized keys for that unit.

Further, by using a date and time based access code in the electronic key corresponding to the time the key was made, the system can automatically determine which electronic keys are the most recently authorized keys prevent lock access by previously authorized keys and eliminate the need to keep an inventory of preprogrammed keys. In addition, the dual communication links in the utility device of the system enables the utility device to communicate with the system manager as well as communicate with individual locks, simplifying the system and making lock auditing easier.

### BRIEF DESCRIPTION OF THE DRAWINGS

FIG. 1 is a block diagram illustrating the main components of a security system according to one embodiment of the invention;

FIG. 2 is a representative block diagram of a lock according to one embodiment of the invention;

FIG. 3 is an exploded view of a reprogrammable key used in one embodiment of the invention;

FIG. 4 is a chart illustrating data fields defined in the lock and in the reprogrammable key for operating the lock according to one embodiment of the invention;

FIG. 5 is a chart illustrating data fields for a query key according to one embodiment of the invention;

FIG. 6 is a chart illustrating data fields for a limited use key according to one embodiment of the invention;

FIG. 7 is a flow diagram illustrating how a limited use key is programmed and used according to one embodiment of the invention;

FIG. 8 is a chart illustrating data fields for a maintenance key according to one embodiment of the invention;

FIG. 9 is a chart illustrating data fields for a construction key according to one embodiment of the invention;

FIG. 10 is a flow diagram illustrating a method of programming a lock according to one embodiment of the invention;

FIG. 11 is a flow diagram illustrating another method of programming a lock according to one embodiment of the invention;

FIG. 12 is a flow diagram illustrating a method of programming a common access lock according to one embodiment of the invention;

FIG. 13 is a perspective view of a key encoder according to one embodiment of the invention; and

FIG. 14 is a perspective view of a utility device according to one embodiment of the invention.

### DETAILED DESCRIPTION OF THE EMBODIMENTS

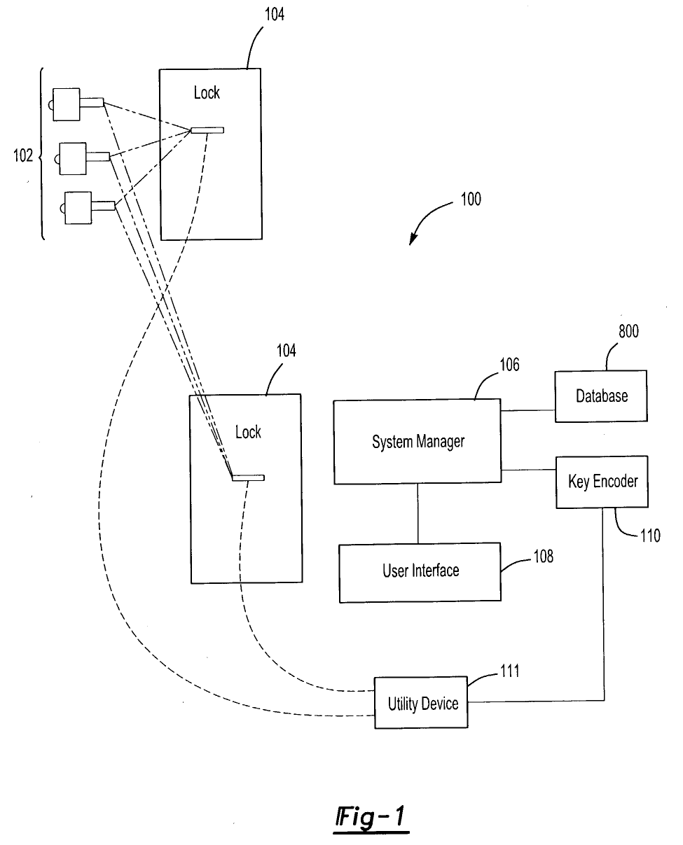

The invention is generally directed to a security system and security system components that can be used in a housing complex, such as a multi-family dwelling, a condominium complex, apartments, dormitories, or other similar complex. FIG. 1 is a representative diagram illustrating the main components of a security system 100 according to one embodiment of the invention. Each component will be explained in greater detail below with respect to the other figures. Generally, the system 100 includes reprogrammable keys 102 that are issued to tenants, personnel, and anyone else requiring access to one or more portions of the housing complex. The keys 102 can be programmed with different identification codes, access levels, and even access times to maintain security while still making access convenient for authorized people.

Each area requiring controlled access is equipped with an electronic lock 104. The lock 104 can be programmed with any desired authorization codes to ensure that only authorized keys can open the lock 104. The lock 104 may also include a memory that can record a given key's identification information each time a key 102 is used to access the lock 104. This information stored within the lock can later be downloaded to generate an audit trail showing a selected number of transactions, including the time, date, and type of key used in each transaction.

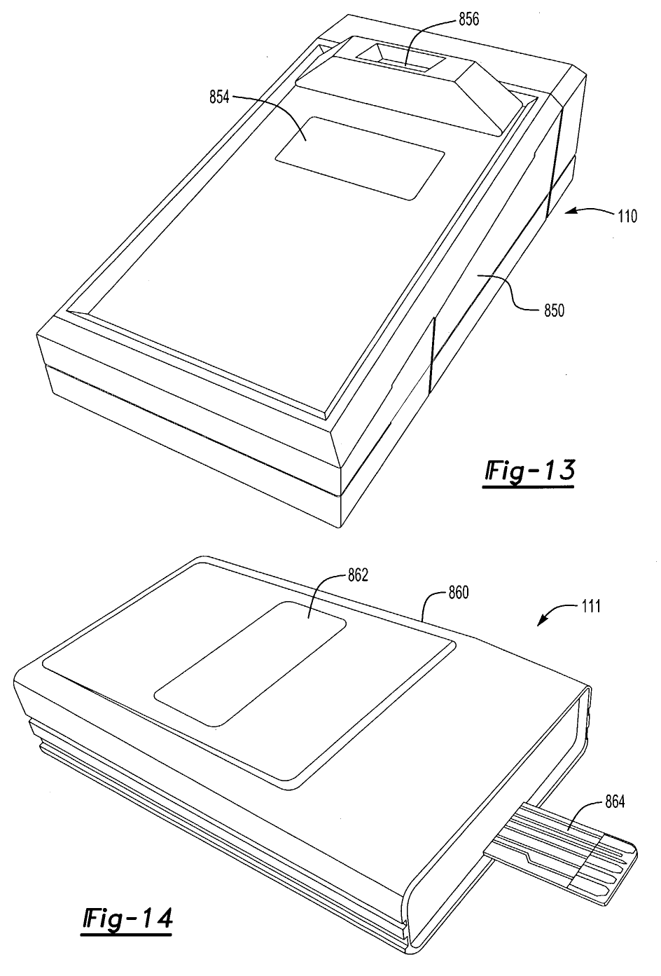

A system manager 106 acts as a central database and clearinghouse for lock and key data management and for key creation. The system manager 106 may be implemented as software in a personal computer equipped with an interface 108 that can accept keys for programming data into and reading data out of the keys 102 as well as receive and display data. In one embodiment, the system 100 also includes key encoder 110 that codes keys and transfers data to and from the system manager 106. The key encoder 110 be any device that can accommodate the keys 102 and communicate with the system manager 106 via a communications port (not shown). One example of a key encoder 110 is shown in FIG. 13 and will be described in greater detail below. Other interface 108 components for communicating with the system manager 106 may include a computer display, a keyboard, and/or a touch screen. The system manager 106 performs all key management functions via the computer and, when necessary, passes data and commands to the key encoder 110. A stand-alone utility device 111 may also be included in the system 100 to act as a portable interface between the system manager 106 and the locks 104. Each of these system components will be described in greater detail below with respect to the Figures.

Lock

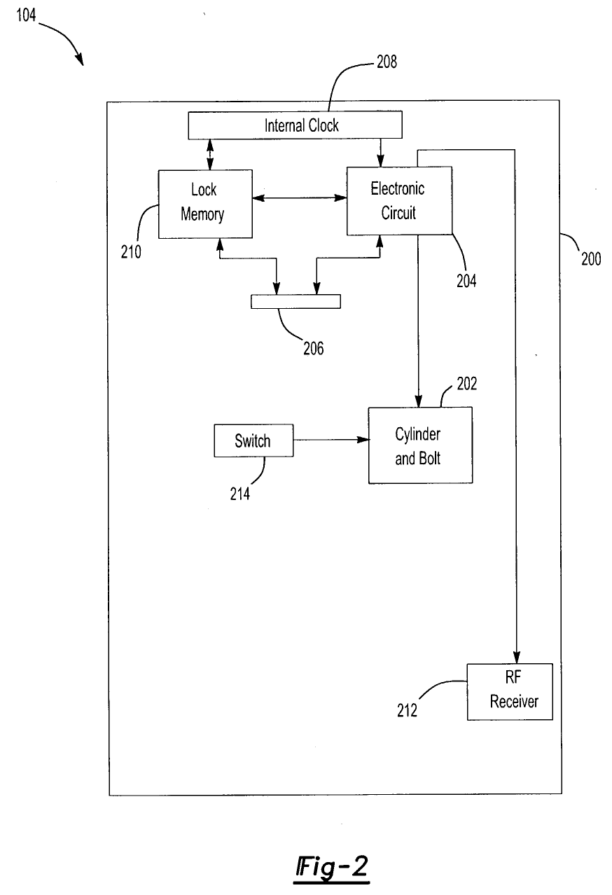

a. FIG. 2 is a representative block diagram illustrating a lock according to one embodiment of the invention. The lock 104 can be any known lock, such as one with a cylinder and bolt mechanism, that can be adapted for electronic control. In one embodiment, the lock 104 components are placed in a housing 200 and includes a cylinder and bolt 202 that are movable between an unlocked and a locked position. The cylinder and bolt 202 are operatively coupled to an electronic circuit 204 that controls movement of the cylinder and bolt 202. The electronic circuit 204 is also coupled to a key slot 206 so that the circuit 204 can read and evaluate data on an inserted key 102 and operate the cylinder and blot 202 based on the evaluated data.

b. In one embodiment, the lock 104 includes an internal clock 208 that generates real time date and time information. The date and time information may be used to control lock access and to act as a date/time stamp for lock transactions to be included in an audit trail. The internal clock 208 is first set by the system manager 106; in one embodiment, the utility device 111 is first connected to the key encoder 110 so that current (correct) time in the system manager 106 can be transferred through the key encoder 110 to a real-time clock chip in the utility device 111. The utility device 111 can then be disconnected from the key encoder 110 and connected to the lock 104 so that the current time in the utility device 111 can be transferred to the lock's internal clock 208.

c. Access data and audit trail information, which includes date and time information, as well as any other information identifying and/or controlling operation of the lock, such as a lock is stored in a lock memory 210. The lock memory 210 is accessible by the electronic circuit 204 so that the circuit 204 can read, for example, data corresponding to data fields in the keys 102 to control whether a given key will move the cylinder and bolt 202 into an unlocked position. The lock memory 210 can be any known readable and writable memory device.

d. An RF receiver 212 may also be incorporated into the lock 204 to receive RF signals from an RF communication chip on the key 102, making it more suitable for handling excessive daily use without undue mechanical wear. An AC power source (not shown) should be coupled to the RF receiver 212 so that the receiver 212 can continuously scan the area around the lock 104 for an RF signal from the key 102. Although RF receivers 212 are particularly suitable for common access locks, which handle excessive daily use, the RF receiver 212 can be incorporated into any lock 104 at any location desiring contactless entry.

e. The lock 104 may also include a switch 214 mounted on the inside half of the lock so that a tenant can access the switch while inside the dwelling. The switch 214 can be configured to operate as a passage switch or a privacy switch, depending on the desired operation. In one embodiment, the switch 214 is configured via a programming key and a configure unit key when the lock 104 is installed in a unit. These processes are explained in greater detail below.

f. Configuring the switch 214 as a passage switch allows the tenant to unlock the door from the inside without using a key. In this embodiment, the switch 214 can be turned between an OPEN position and a LOCK position. When the switch 214 is in the OPEN position, circuitry in the lock 104 will place the lock 104 into an unlocked mode. The lock 104 will remain unlocked as long as the switch 214 stays in the OPEN position, allowing free access without a key and ignoring any key that is inserted into the lock (e.g., the lock will not record any key information if a key is inserted while the switch is in the OPEN position). If the switch is changed to the LOCK position, the lock 104 will remain locked unless a valid key is inserted into the lock 104 or until the switch 214 is changed back to the OPEN position.

g. Alternatively, the switch 214 may be configured as a privacy switch that can deny access to all keys except a valid tenant key or a master key. In this embodiment, the switch 214 can be moved between a NORMAL position and a PRIVACY position. When the switch 214 is in the PRIVACY position, the lock 104 can be opened only by a master key or a valid tenant key and not any other authorized keys (e.g., keys issued to maintenance personnel). When the switch 214 is in the NORMAL position, the lock 104 resumes normal operation, allowing all authorized keys to open the lock. The specific manner in which the switch 214 is configured to act as a passage switch or privacy switch is within the capabilities of one of ordinary skill in the art.

Reprogrammable Key

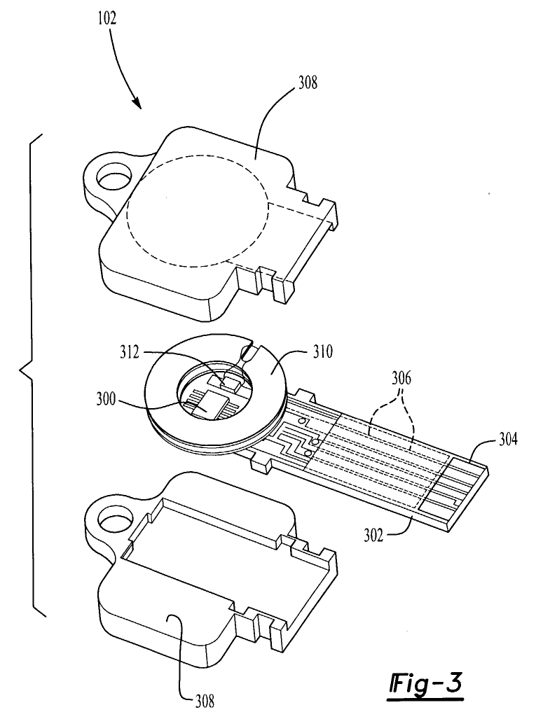

a. FIG. 3 is an exploded view of a key 102 according to one embodiment of the invention. The key 102 includes a reprogrammable computer chip 300 on a circuit board 302 designed to fit into the key slot 206 of the lock 104. The circuit board 302 includes an electrical contact 304 and one or more electrical traces 306 that connect the contact 304 to the chip 300. The chip 300 includes a programmable memory that stores a selected amount of data (e.g., 1000 bytes).

b. The chip 200 is protected by a key bow 308. The bow 308 preferably is made of a water and temperature resistant material and seals the chip 300 from harsh environmental conditions. In one embodiment, as shown in FIG. 2, an end portion of the circuit board 302 is sandwiched between two pieces forming the key bow 308. The key bow 308 is preferably configured like a conventional key so that it can be attached to a key ring or key hook.

c. The key 102 may also include an optional RF communication function in the chip 300 or a separate RF communication device to allow the key 102 to act as a proximity key. More particularly, the RF communication function allows the key 102 to open the lock 104 remotely if the lock 104 has a corresponding RF receiver 212. In the example shown in FIG. 3, a ring-shaped RF antenna 310 surrounds the computer chip 300 and a charging capacitor 312. The key bow 308 covers and protects the RF antenna 310 and charging capacitor 312 along with the chip 300.

Key Types

a. One embodiment of the inventive system 100 includes 14 possible key types, which include: programming key, master key, zone key, tenant key, inhibit tenant key, inhibit master key, inhibit zone key, configure all key, configure unit key, configure passage key, query key, limited use key, maintenance key, and construction key. Each of these functions will be described in greater detail below.

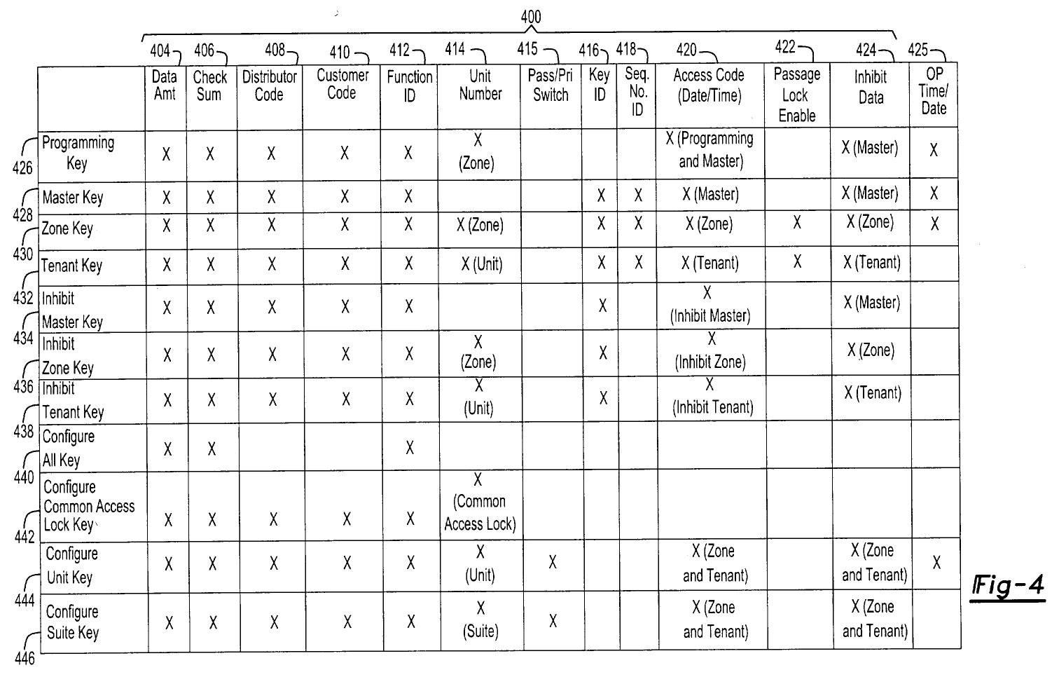

b. FIGS. 4 through 6 and 8 are charts illustrating data fields 400 that may be defined in the computer chip 200 to hold data customizing a given key's function. These fields are also defined in the lock memory 210 to hold data to be compared with corresponding data in the key 102 to control lock operation. In this description, the same reference numerals will be used to refer to the data fields 400 and the data held in the data fields for clarity. As can be seen in the charts, not every data field will be used by every key type. Instead, different key types will hold data in different combinations of data fields; the charts illustrate which data fields contain data for particular key types. Further, the lock circuit 204 will treat data in different key types differently. For simplicity, the data fields will be generally described below and then later described more specifically with respect to each of the different key types. Further, although FIGS. 4 through 6 and 8 illustrate one specific configuration and order for the data fields, those of ordinary skill in the art will understand that other configurations are possible without departing from the scope of the invention. In one embodiment, each data field comprises one or more bytes of memory and each function in the key is allocated a specific number of bytes.

c. In this particular example, the data is stored in memory locations that are each one byte long. The first data field in this example is a “data amount” field 404 that holds data indicating how much memory is used by the key 102. As will be shown below, different types of keys 102 contain different amounts of data. A “check sum” field 406 represents the number of bytes used in the key 102 to confirm that the number of bytes received by the lock 104 matches the number of bytes in the key 102.

d. The next set of fields stores basic key identification information. The “distributor code” field 408 and the “customer code” field 410 identify a particular property site in which the key 102 is operational. More particularly, the distributor code 408 identifies a central distributor that distributes locks and keys to multiple customer sites, while the “customer code” field 410 contains information that distinguishes one customer site from another customer site having the same distributor.

e. A “function ID code” field 412 identifies the key type. In one embodiment, each key type contains a unique, predetermined function ID code. This function ID code tells the lock circuit 204 which data fields to read, how to interpret them, and how to respond to the data in the key 102. As a result, the lock circuit 204 will perform different operations based on the key's type, as identified by the function ID code.

f. Next, a “unit number” field 414 contain information about the specific location where the key will operate (if the field 414 is in the key 102) or identifying the location of the lock (if the field 414 is in the lock memory 210). For example, if the key 102 is a tenant key, the “unit number” field 414 will contain the number of the unit that the key 102 will open. Similarly, if the key 102 is a zone key, the “unit number” field 414 will contain the number identifying the zone, which may encompass multiple units, where the key will operate. In one embodiment, the value stored in the unit number field 414 in the lock memory 210 will point to a logical description of the lock used by the system manager 106. For example, if the lock 104 is assigned a unit number of 35, indicating that it is the 35th lock to be assigned a unit number, the system manager 106 may match the unit number with the logical description of the lock 104 (e.g., “Apartment #534”) and relay the logical description to the end user. Similar matching between the unit number 414 and the logical lock description can occur for common access locks, suite locks, and/or other lock locations.

g. A passage/privacy switch field 415 configures the lock switch 214 to act as either a privacy switch or a passage switch, as explained above with respect to FIG. 2.

h. A “key ID” field 416 provides a unique key ID number. If the “key ID” field 416 is one byte long, the key may have one of 64 possible key ID numbers. The “key ID” field 416 may be used to distinguish different keys that can open the same lock(s) or otherwise have the same functions. Distinguishing among keys having the same functions is useful for tracking key usage by two people living in the same unit, for assigning new keys by incrementing the “key ID” field 416 from the last assigned key ID value 416 , and for disabling old keys by inhibiting operation of keys having particular key ID values 416, which will be described in greater detail below.

i. A “sequence number ID” field 418 indicates the order in which the key was made. The system manager 106 uses data in this field 418 to properly sequence audit trail transactions

j. One or more “access code” fields 420 contain date and time data and may occupy multiple fields to accommodate year, month, day, hour, and minute data. The access code corresponds to the date and time that the key was made. This data may be used by the lock circuit 204 to identify the most current keys and ignore keys with less current access codes. The data in the “access code” field 420 ensures that a given lock 104 will recognize only the most recently authorized keys without requiring an operator to reprogram the lock memory 210 itself. In one embodiment, the lock memory 210 stores different access codes 420 for each key type to ensure that the lock 104 will operate only for the most recently authorized keys of each type; as will be explained below, different key types may have different access codes 420 that are updated at different times.

k. Next, a “common access lock enable” field 422 holds common access lock enable data. In one embodiment, the common access lock enable field 422 is 8 bytes long, and each bit in each byte of the field 422 represents one common access lock. An 8-byte field can therefore accommodate access data for 64 unique common access locks, each common access lock having its own unique ID. For example, the least significant byte in the common access lock enable data fields 422 on a given key 102 may be “0000 0001”. This would indicate that the key 102 can open common access lock 1. Similarly, if the byte contains “0000 0011”, this indicates that the key 102 can open common access locks 1 and 2. A key with “1111 1111” as its least significant byte would be able to open common access locks 1 through 8. If all of the bits in the “common access lock enable” field are 1, then the key 102 can open any common access lock on the property.

1. “Inhibit data” fields 424 contain a data array where each bit in the array corresponds to one “key ID” number. For example, a key having a key ID of 1 in the “key ID” field 416 is represented by the first bit in the “inhibit data” array. Each bit will indicate whether its associated key is active (operational) or inhibited (non-operational). In one embodiment, if the bit is set to 1 for a given key ID 416, that key will function in the lock. If the bit is set to 0 for a given key ID, then that key will not function in the lock. For example, if the least significant byte of the “inhibit data” field 424 contains “0000 1100” and all other bytes in the field 424 are also “0”, then it indicates that keys having key IDs 3 and 4 are operational and all other key IDs are non-operational. The “inhibit data” field 424 allows locks to be reprogrammed if a key with a given key ID number is lost by simply changing the bit associated with the lost key's ID number in the key 102 and then uploading the inhibit data information 424 on the key to the lock member 210, as will be described in greater detail below. In one embodiment, the “inhibit data” field 424 is 8 bytes long, accommodating 64 different key IDs.

m. “Operation date/time” fields 425 indicate the dates and times during which the key will be operational. This information is compared with the date/time data in the lock memory 210 to determine whether the key is authorized to open the lock 104 at a given date/time. By indicating the time window during which the key will be operational, the key 102 has a built-in expiration, ensuring further security. The operation date/time information can, for example, prevent a previously authorized user from accessing locks after the authorization period is over or allow access to a common area only during a selected time window. As shown in the Figures, not every key type has data in every field. Unique features of each key type's operation will now be explained.

n. A programming key 426 is used to program a lock to accept valid master keys and zone keys, so it contains both access codes 420 and inhibit data 424 for both a master key 428 and a zone key 428 as well as its own programming key access code 420 to ensure that the lock 104 will only accept the most recently activated keys. However, because the programming key 426 is not associated with, for example, one particular zone or unit, the unit number field 414 remains unused in the programming key 426. More details of the programming key's operation will described later with respect to FIG. 8.

Normal Access Keys

a. Normal access keys are any keys that are used to open one or more locks. Access keys include master keys 428, zone keys 430, and tenant keys 432. Access keys have similar formats and operations, as will be noted below. Although limited use keys (described under “Specialty keys”) also open one or more locks, their operation is somewhat different than master, zone, and tenant keys and will be described separately.

b. The master key 428 is programmed to open any lock 103 having a distributor code 408, customer code 410, and access code (date/time stamp) 420 matching the master key 428 being inserted into the lock 104 as well as valid master key inhibit data 424 for the master key ID 416 of the inserted key. In one embodiment, all active master keys 428 have the same access code 420 so that the door locks only need to store one master key access code 420 even if the active master keys 428 themselves were made at different times. To do this, the system manager 106 saves the date/time stamp given to the first master key made and uses this date/time stamp as the access code in subsequent master keys.

c. Each master key may have a unique key ID 416 to allow a given property to have more than one uniquely-identified master key. In one embodiment, if the “key ID” field 416 is one byte long, 64 possible unique master key ID's are possible. A lost master key may be replaced by a new master key having a different key ID 416; as noted above, creating a replacement key also involves changing the array stored in the “inhibit data” field 424 to deactivate the key ID 416 of the lost master key. Regardless of the reasons why the array in the “inhibit data” field 424 is changed (e.g., because of a lost key or because of a new access code), the new master key 428 having the new “inhibit data” array 424 is inserted into every lock 104 requiring accessibility by the master key to load the new array into the lock memory 210. This ensures that only keys having active key ID's 416 will be able to open the lock 104.

d. If over time the number of master key ID's is used up (e.g., indicated by the lack of available active bits in the “inhibit data” field 424), the master keys 428 may be reprogrammed to allow creation of more master keys by changing the access code 420 of each active master key for the property and inserting the master key with the new access code into each lock on the property. Inserting the new master key uploads the new access code 420 into the locks, locking out all previously made master keys having the earlier access code. If the access code 420 is updated, the “inhibit data” field 424 should also be changed to reflect the key IDs of the active master keys having the new access code 420.

e. Like the master key 428, the zone key 430 opens any lock 104 having a matching distributor code 408, customer code 410, access code 420, and valid key inhibit data (in this case, valid zone key inhibit data) 424. However, the zone key 430 also includes a zone number in the “unit number” field 414. This zone number 414 that must match the zone number stored in the lock memory 204 for the lock 104 to open. Further, as shown in FIG. 4, the zone key 430 will contain data in the common access lock enable field 422 to control which common access locks the zone key 430 can open. Like master keys 428, active zone keys 430 may also have the access code 420 of the first zone key made even if other zone keys are made at different times. This allows the locks to store only one zone key access code 420, making it convenient to add and replace zone keys 420 without having to change the zone key access code 420 and thereby affect the operation of other valid zone keys.

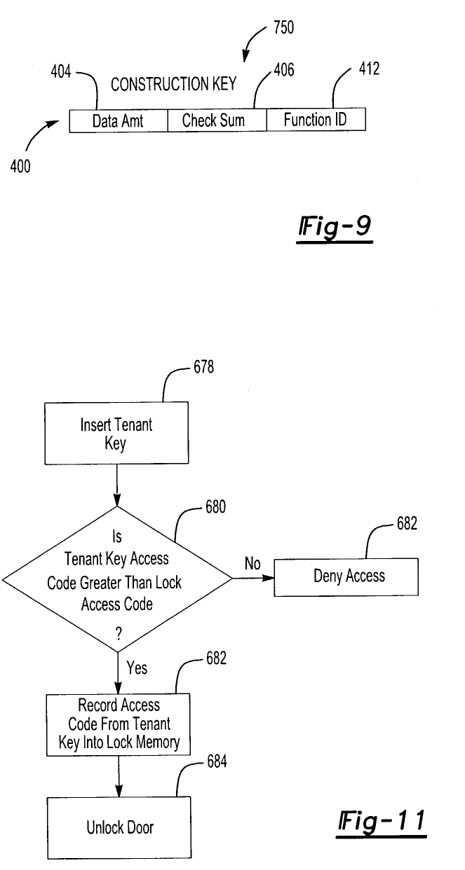

f. Tenant keys 432 have information similar to zone keys 430 except that they contain a unit number in the “unit number” field 414. To open a lock 104, the unit number 432 in the tenant key 432 must also match the unit number stored in the lock memory 210 along with matching all the other lock data (e.g., distributor code 408 and customer code 410). Further, the tenant key access code 420 stored in the lock memory 210 ensures that the lock 104 will accept only the most current tenant keys 432 that are explicitly given access by the system manager 106. Tenant keys 432 having less current access codes than the access code stored in the lock memory 210 and/or keys that have inactive key ID's 416 according to the array stored in the “inhibit data” field 424 will not be able to open or reprogram the lock 104. In one embodiment, if the tenant key access code 420 is more recent than the tenant key access code stored in the lock member 210, the lock member 210 will replace its own tenant key access code with the more recent access code 420 on the key, thereby automatically reprogramming the lock 104 to accept the new tenant key 423 without manual reprogramming of the lock 104 itself. FIG. 9 illustrates one way in which the tenant key can be used to reprogram a lock in greater detail using a programming key. The common access lock enable field 422 in the tenant key 432 operate in the same manner as explained above with respect to zone keys 420.

Inhibit keys

a. Inhibit keys, such as an inhibit master key 434, inhibit zone key 436, and inhibit tenant key 438, are used to prevent one or more keys from opening the lock 104. More particularly, the inhibit keys can instruct a lock 104 to block a key that otherwise has a current access code 420 and matching identification information (e.g., distributor code 408, etc.). This prevents the blocked key from operating without blocking other current keys having the same access code 420 as the blocked key. As noted above, multiple current keys that are otherwise identical can be distinguished from each other by their key ID numbers 416. By changing the inhibit data array 424 in the lock memory 210, the operator can control which specific key IDs 416 can open the lock.

b. Inhibiting a key having a given key ID 416 can be conducted by creating an inhibit key 434, 436, 438 containing the new inhibit data array 424 and inserting the inhibit key 434, 436, 438 into the affected lock(s) 104. The lock circuit 204 will record the new inhibit data array into the lock memory 210 and lock out access to the inhibited key IDs indicated in the inhibit data array 424.

c. If the operator wishes to inhibit all active keys, the operator may, through the system manager 106, update the access code in a key with the current date and time and reset all of bits in the inhibit data array to “1”, thereby allowing access to all keys having the new access code. This is more efficient than changing the inhibit data array 424 to block all active keys and provides room in the inhibit data field 424 for creating future keys. Inserting the key 102 with the new access code 420 into each lock memory 210 will block all keys, regardless of type, with the older access code and reset the lock to allow keys having the updated access code 420 to unlock the lock 104. More particularly, the lock circuit 204 will detect that the access code 420 in the key 102 is more recent than the access code 420 stored in the lock memory 210 and replace the lock access code 420 with the access code 420 on the key.

d. If a lock 104 is accessible by more than one key 102 and if the operator has access to a key having the same function as the key to be inhibited and a key ID 416 that the operator wishes to keep active, the operator may avoid having to reprogram the lock 104 with a specialized inhibit key altogether. Instead, the operator may allow the user of the active key to reprogram the lock automatically the next time he or she inserts the active key into the lock. To do this, the operator may take a current active key and create a duplicate key having identical key data except for an updated inhibit data array 424 to block the inhibited key. When the duplicate key is inserted into the lock 104 and the lock circuit 204 verifies that the duplicate key is a valid, active key, the lock circuit 204 will record the updated inhibit data array 424 into the lock memory 210, reprogramming the lock 104. As a result, the inventive system allows updating of the information in the lock memory 210 simply by rekeying a user's key 102, without requiring any separate reprogramming of the lock memory 204 through manual means.

e. The inhibit tenant, inhibit zone, and inhibit master keys operate in generally the same manner and differ primarily in the area identified by the “unit number” field 414 (e.g., whether the unit number 414 identifies a zone or unit, etc.). If the inhibit key is an inhibit master key, the unit number field 414 is left blank because, as explained above, master keys themselves do not contain data in the unit number field 414.

Configuration Keys

a. Configure all keys 440, configure passage keys 442, configure unit keys 444, and configure suite keys 446 are used to program information into the lock memory 210. The configure all key 440 is primarily used during lock manufacturing and is not used by an end user. As shown in FIG. 4, the configure all key 440 does not contain any specific information; instead, virtually all of the data fields are left blank. When the configure all key 440 is inserted into the lock, it clears the distributor code 408, customer code 410, unit number 414, key ID 416 and any audit trail data from the lock memory 210 and sets the lock to “factory mode”. Locks in “factory mode” are only accessible with a construction key, which will be described in greater detail below.

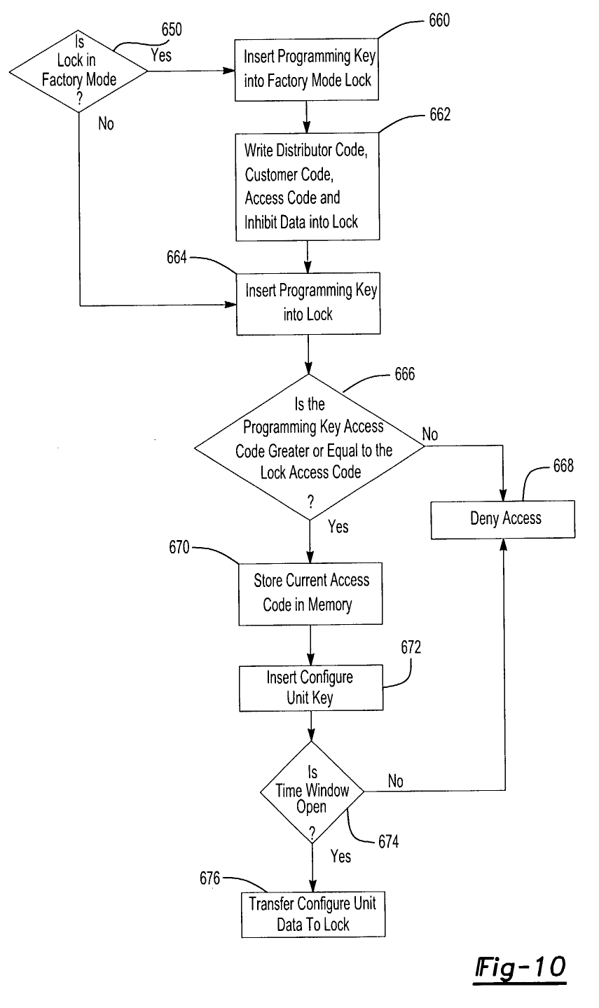

b. The configure passage key 442 is used to program a passage number into a lock, while the configure unit key 444 is used to program a unit number and other lock characteristics (e.g., the way the privacy/passage switch 214 will operate) into a lock 104. The way in which programming takes place generally is explained in greater detail below with respect to FIGS. 9 and 10. The configuration keys themselves simply contain data to be transferred to the lock memory 210. For example, the configure unit key 444 may contain the distributor code 408, customer code 410, unit number (in unit number field 414), tenant key access code 420, and tenant key inhibit data 424 as information to be programmed to the lock memory 210, while the configure passage key 442 contains the distributor code 408, customer code 410 and the common access lock number (in unit number field 414).

c. A variation of the configure unit key 444 is a configure suite key 446. Suites are areas having more than one unit. The configure suite key 446 programs a suite number into a lock 104. The data information is the same as the configure unit key 444 except that an additional data field stores the number of units within the suite (not shown). Otherwise, the configuration process for configure unit keys 444 and configure suite keys 446 are identical. Locks configured by the configure suite key 446 operate in the same way as locks configured by the configure unit key 444.

Specialty Keys

a. Query keys 500, limited use keys 600, maintenance keys 650, and construction keys 700 are unique keys designed for specialized functions.

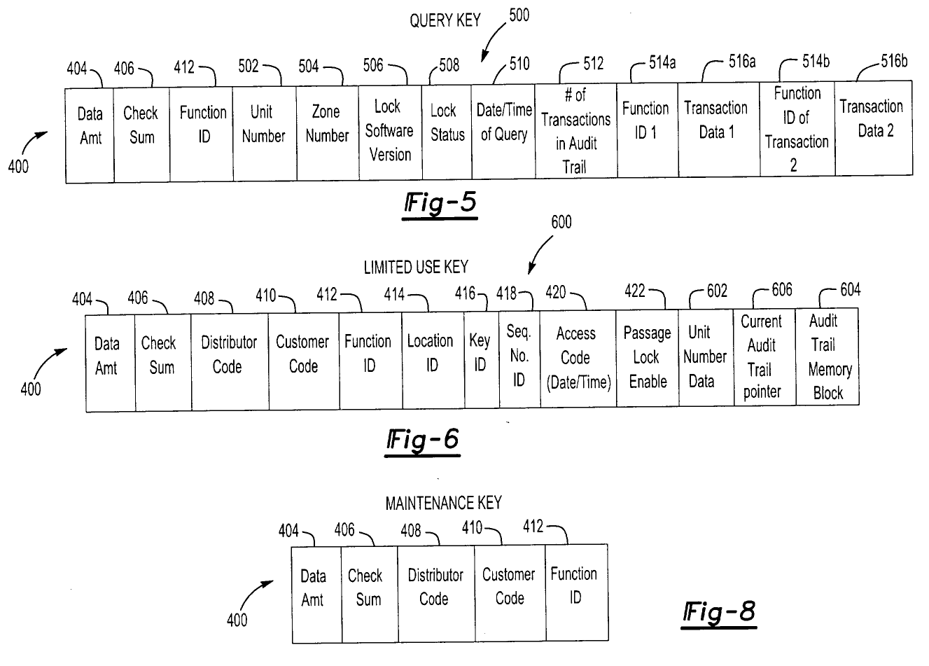

b. FIG. 5 illustrates data fields 400 in one embodiment of a query key 500. The query key 500 is used to download an audit trail from the lock memory 210 and can be used in any unit at any site; as shown in FIG. 5, the query key 500 does not contain a distributor code or customer code linking the key to a particular site. Instead, the query key 500 itself includes only the data amount 404, check sum 406 and function ID 412 identifying the key as a query key 500. Further, unlike the other keys described above, the data fields in the query key 500 do not themselves contain any data associated with a specific key or lock. Instead, the fields are designed store the audit data from the lock memory 210 in an organized format. Downloading data from the lock memory 210 to the query 500 simply requires inserting the query key 500 into the lock 104 and keeping the query key 500 in the lock 104 until the downloading operation is complete. In one embodiment, the lock 104 may have audible and/or visual signals indicating completion of a download operation.

c. For simplicity, FIG. 5 shows a query key 500 that holds an audit trail containing two transactions, but in practice query keys 500 can hold many more transactions. In one embodiment, the lock memory 210 first downloads basic identification information to the query key 500 before downloading the audit trail itself, such as the lock's unit number 502, the lock's zone number 504 (verifying that the lock is properly zoned), the lock's software version number 506, if desired, the lock's status byte 508 (verifying the lock's battery operation and clock chip status), the lock's current date and time 510 according to the lock's real time internal clock 208, and the number of transactions in the audit trail 512.

d. In this example, each transaction in the audit trail will contain the function ID 514a, 514b of every key used to open the lock 104, and transaction data 516a, 516b, such as the key ID number identifying the specific key used, a key sequence number, and a date/time stamp indicating the date and time, according to the lock's internal clock 208, at which the transaction occurred. Other information or selected combinations of information can be included in the transaction data 516a, 516b without departing from the scope of the invention.

e. Limited use keys 600 are designed to open doors for a limited time period during one calendar day. Limited use keys 600 may be created and issued to, for example, maintenance personnel authorized to access a given unit only for a limited time period. In one embodiment, the limited use key 600 is designed to allow access only on the day that the limited use key 600 is made, even if the operator programs the key for a longer time period.

f. FIG. 6 illustrates fields in a limited use key 600 according to one embodiment of the invention. In this embodiment, the limited use key 600 has a distributor code 408 and customer code 410 like the other keys described above to identify the property at which the limited use key 600 can be used.

The key 600 also includes a limited use key access code 420, which must be larger (more recent) than a limited use access code stored in the lock memory 210 for the lock 104 to open. The field also includes common access lock enable fields 422 representing common access locks that the limited use key 600 is authorized to open. A series of unit number fields 602 indicates the unit numbers that the limited use key 600 is authorized to access. This allows the key holder to access multiple units with one limited use key 600.

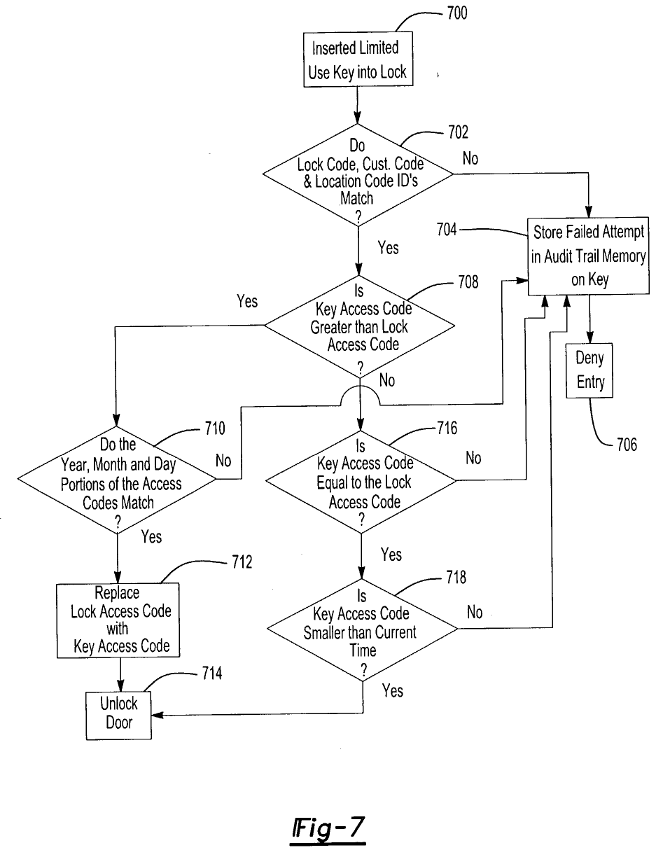

g. FIG. 7 is a flow diagram illustrating the operation of the limited use key 600. Because limited use keys 600 require tighter security measures, authorizing access for a limited use key 600 is more complicated than other key types and goes beyond simple code matching. If the operator wishes to allow the limited use key 600 to open a given unit only once, the current key management system access code will be programmed into the limited use key 600. When the limited use key 600 is inserted into the lock 104 for the first time (block 700), the lock circuit 204 checks whether the distributor code 408, customer code 410, and unit number 414 in the limited use key 600 match the corresponding codes stored in the lock memory 210 (block 702). If the codes do not match at this point, the lock circuit 204 records the failed entry attempt in the lock memory 210 (block 704) and denies entry to the unit (block 706).

h. Next, the lock checks whether the limited use key access code 420 is larger than the limited use access code stored in the lock (block 708). Note that the limited use access code in the lock memory 210 at this time will be the limited key access code of a previously used limited use key for reasons explained below.

i. If the key's access code is larger than the lock's access code, the lock then checks whether the year, month and day portion of the key's access code matches the date in the lock's real time clock (block 710). If so, the lock circuit 204 will then compare the time portion of the key access code with the current time in the lock's internal clock (block 712). If the time portion in the key is larger than the current time indicated by the lock, the lock circuit 204 replaces the lock access code stored in the lock memory

j. If the same key is reinserted into the lock, the lock will first see that the access code in the key is the same as the access code in the lock (because the lock recorded the key's access code at block 712). Because the two access codes match (block 716), the lock circuit 204 will then compare the key's access code with the current time in the lock's real time clock (block 718). If the key's access code is smaller than the current time, the lock will not open (blocks 704 and 706). This process ensures that a limited use key cannot be used more than once on the same lock.

k. If the operator wishes to allow access to a unit over a selected time period, the limited use key access code 420 may be programmed to reflect a time window during which the limited use key 600 is operational. In one embodiment, the limited use key 600 is programmed with a current key management system access code plus a selected time value (e.g., 3 hours). This ensures that the key's access code will remain larger than the current time in the lock's real time clock for the selected time period even if the key is inserted repeatedly into the lock. As long as the key's access code is larger than the current time, the lock will open (block 718). In one embodiment, if the key includes multiple unit numbers, any time restrictions programmed into the limited use key 600 applies to all units. For example, if the limited use key 600 does not specify a time window and is programmed to open three units, the key 600 can open each of the three units only one time. If the key does specify a time window (e.g., 3 hours), the key 600 can open all three units any number of times for 3 hours after the key 600 was made.

1. In one embodiment, the limited use key 600 also includes extra fields 602, 604, 606 for storing an internal audit trail. Every time the limited use key 600 is inserted into a lock, regardless of whether the key actually opens the lock, the key 102 stores the current date/time stamp of the lock, the lock's unit number and the lock's status information in an audit trail memory block 604 on the key 600. An audit trail pointer 606 indicates to the lock circuit 204 where to write the next audit transaction on the limited use key 600. When a worker returns a limited use key 600 to the operator, the downloaded data from the key indicates which units the worker entered, the time at which the worker entered the units, any common access locks opened by the key, and whether the worker tried to access other units. The lock status information stored on the key in the audit trail memory block 604 also reflects lock battery condition, integrity of the real time clock chip in the lock, lock traffic, and other factors relating to the lock's condition.

m. FIG. 8 illustrates a diagram of a maintenance key 650 according to one embodiment of the invention. Maintenance keys 650 can be used to check the condition of a lock 104. In one embodiment, each maintenance key 650 can store information from up to 70 different unit and/or suite doors. Multiple maintenance keys 650 can be made and issued if more doors are to be checked with the key 650.

n. The maintenance key 650 contains the data amount 404, check sum 406, distributor code 408, customer code 410 and function ID 412. The maintenance key 650 then indicates the number of lock records 652 stored on the key. The first record in the maintenance key 650 is then indicated by the lock type 654a (e.g., unit lock or suite lock) and the data 656a for that lock. The lock data 656 can include the unit or suite number corresponding to the lock, current voltage status of the lock's battery, the number of times the lock has been opened/closed, the lock's software version, and the current date/time data for that lock. The lock type 654b for the second lock marks the start of the second record in the maintenance key, and the data 656b for the second lock. Records for additional locks are saved on the maintenance key in the same manner as the first two records.

o. Construction keys 750, as shown in FIG. 9, are used to open locks that are in factory mode (i.e., locks that have not been programmed with distributor or customer codes). Construction keys 750 will contain the minimum data used for key operation, such as the amount of data on the key 404, check sum 406, and the function ID 412. As explained in greater detail below, the construction key 750750 will be inoperative once a programming key 426 has been inserted into the lock 104.

Lock Programming

a. As noted above with respect to FIGS. 4 through 6 and 8, each key 102 stores data in different data field combinations. The lock 104 will therefore respond differently to different keys. FIGS. 9 and 10 show two specific examples for programming the lock 104 to accept and reject selected keys 102. Generally, the lock 104 will deny access if the access code in the key is smaller than the corresponding access code in the lock, allow access if the key access code and the lock access code are the same, and allow access and record the key access code and any updated data in the key into the lock 104 if the key access code is greater than the lock access code. In all cases, the lock 104 will operate based on the comparison between the key access code and the lock access code.

b. FIG. 10 is a flow diagram illustrating one method of programming a new lock 104 using the programming key 426. Programming the lock instructs the lock to accept selected access keys. Generally, the programming key 426 assigns a distributor code 408, a customer code 408, master key 428 information and zone key 430 information to a new lock 104. If the lock 104 is initially received directly from the factory, it will be in “factory mode” and can be opened only with a construction key (block 650). This ensures that construction workers can obtain access to all areas of the property and not accidentally lock out other workers.

c. Once the locks 104 for a given site are installed, the programming key 426 is inserted into each lock 104 to dedicate the lock to that site (block 660). More particularly, all of the information in the programming key 426 shown in FIG. 4 is written to the lock memory 210 so that the lock 104 can no longer be opened by a construction key or any keys associated with other sites (block 662); at this point, the locks 104 are dedicated to the site corresponding to the distributor code 408 and customer code 410. Because the programming key 426 initializes a lock to accept both master key 428 and zone keys 430, the programming key 426 contains access codes and inhibit data 420, 424 for both master keys and zone keys as well as its own programming key access code. The access codes 420 for both master keys and zone keys stored in the programming key 426 ensure that the lock 104 will be programmed to accept only master keys and zone keys having the current access code 420.

d. After the programming key 426 has been inserted into a “factory mode” lock 104 for the first time (block 660), the lock 104 can be opened only by a master key 428 or a zone key 430 having codes corresponding with the information stored in the lock 104. The lock 104 is then programmed using a programming key 426 in conjunction with the configure unit key 444 so that the lock will accommodate tenant keys 432. To program the lock 104 and dedicate it to a particular unit, the programming key 426 is inserted into the lock (block 664). The lock circuit 204 first compares the programming key access code of the inserted programming key with the corresponding access code in the lock memory 210 (block 666). If the access code on the key is less than the corresponding access code in the lock 104, it indicates that the programming key is a deactivated key with an old access code. As a result, the lock circuit 204 will deny access to the inserted programming key (block 668).

e. If the inserted programming key contains newer programming key access data than the programming key access data stored in the lock memory 210, the lock circuit 204 will store the data from the inserted programming key and inhibit the previous programming key data (block 670), automatically updating the lock 104 to accept the new programming key and reject all other programming keys. More particularly, the lock memory 210 replaces its stored access code with the more recent access code 420 on the programming key 426 to lock out any programming keys with older access data (i.e., programming keys that were made earlier than the newest programming key). Data transferred from the programming key 426 to the lock 104 in addition to the master key access data 420 include the distributor code 408, customer code 410, master key inhibit data 424, and, if desired, daylight saving time data to control the internal clock 208 in the lock 104.

f. Once a valid programming key is inserted into the lock 104, the lock circuit 204 sets a time window (e.g., 20 seconds) during which the lock memory 210can be programmed with the information stored on any valid configure unit key inserted into the lock 104 to dedicate the lock 104 to a particular unit.

g. If a configure unit key is inserted into the lock (block 672) during the time window (block 674), the key data on the configure unit key will transfer to the lock memory 210 (block 676). Once this data is transferred, the lock 104 is ready for access by a tenant key assigned to that unit. In one embodiment, the data transferred to the lock includes the distributor code 408, access code 410, customer code 410, unit number 414 (e.g., corresponding to the unit and the zone), privacy/passage switch configuration data 415, and the zone access code 420.

h. FIG. 11 illustrates a process where the lock is reprogrammed with new tenant data (e.g., if the unit is rented to new tenants). To reprogram a unit lock with new tenant data, the tenant key is first inserted into the lock (block 678). The lock circuit 204 compares the tenant key data stored in the lock (e.g., access code 420 and inhibit data 424), if any, with the corresponding data in the inserted key to see if the inserted key has a greater access code than the tenant key access code 420 stored in the lock (block 680).

i. If the tenant key access code in the key 420 is greater than the tenant key access code in the lock memory 210 (indicating that the inserted tenant key is more recent than any tenant key that had been previously inserted into the lock 104), the lock circuit 204 records the tenant key access code from the inserted key into the lock memory 210 (block 682) and unlocks the door (block 684). This updates the lock to accept the most recently made tenant keys and block all previously made tenant keys, which will have a smaller tenant key access code than the access code now stored in the lock memory 210.

j. More particularly, the lock memory 210 records the tenant key access code 420 of the inserted tenant key 430 as its own tenant key access code 420; because the tenant key access code 420 reflects the date and time the tenant key 430 was made, the lock circuit 204 will be able to distinguish a newly-authorized tenant key from previous, currently unauthorized tenant keys and reprogram the lock memory 210 automatically without any additional instructions or reprogramming from the security system operator.

k. As with other key types, the same tenant key access code 420 may be used for multiple tenant keys even if the keys were actually made at different times. To ensure that only active tenant keys 432 can open a lock 104, the operator can control the array stored in the “inhibit data” field 424 via the system manager 106 to identify which key ID's 416 are valid. In one embodiment, the tenant key access code 420 is assigned to be the date and time at which the first tenant key was made for a given unit. Each time a new tenant key 432 is made after that (e.g., to replace a lost key or to make an extra key), the operator will program, via the system manager 106, the access code 420 of the first tenant key into the new key and change the inhibit data array 424 to activate the key ID 416 of the new key and/or deactivate the key ID 416 of the lost key. This eliminates the need for any additional lock reprogramming via the system manager 106, the programming key, or any other manual means to add the new authorized key and/or block the lost key; instead, the newly-made key will automatically reprogram the lock memory 210 when it is inserted into the lock 104.

1. In one embodiment, the tenant key access code 420 is changed in the system manager 106 only when a tenant moves into or out of a unit, while the tenant key inhibit data array 424 is changed when an existing tenant loses a key or wants an additional key. This ensures that activation of new keys and deactivation of lost keys does not inadvertently deactivate other keys that are still valid. In both cases, the lock memory 210 will be reprogrammed only if the key access code is equal to or greater than the lock access code.

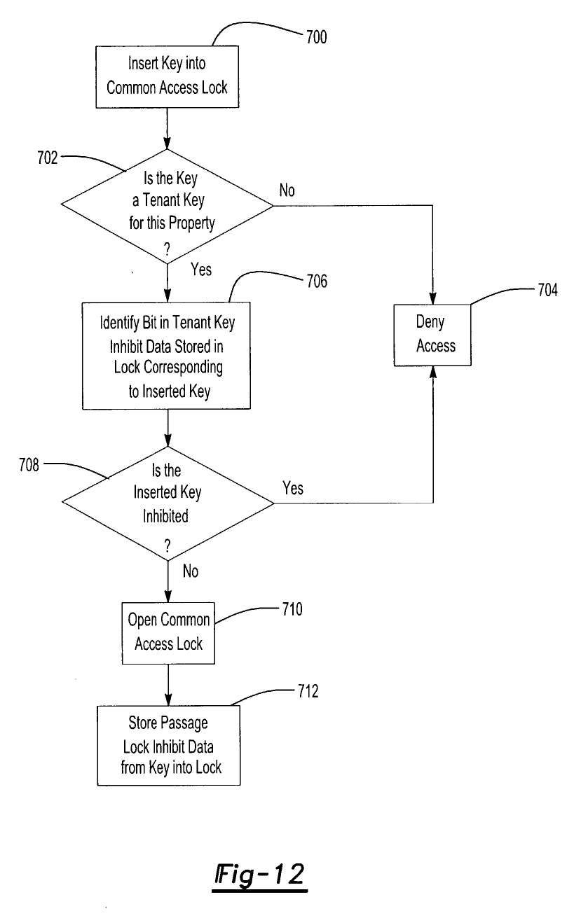

m. The programming key 426 and configure unit key 444 are therefore useful when programming a lock 104 for the first time, programming multiple locks 104 at one time. However, as shown in FIG. 11, a new tenant key 432 can be inserted into an individual lock 104 to reprogram the lock 104 automatically without using the programming key 426 at all. In other words, the lock 104 can lock out old tenant keys and accept new tenant keys simply by inserting the new tenant key alone into the lock 104;the lock circuit 204 will automatically recognize a newly authorized tenant key by its tenant key access code 420, as explained above, without any help from the programming key 426. p0 n. If the lock 104 will be used a large number of times per day, such as in a common access door, exercise room, etc., the lock 104 may be a common access lock having components (e.g., different electronic hardware, physical housing, and/or internal operating software) that can handle heavier usage and record a larger number of lock transactions. The lock memory 210 for a common access lock may include a common access lock identification number to distinguish a particular common access lock from other common access locks. p0 o. FIG. 12 is a block diagram illustrating a method for programming a common access lock using a tenant key 432. Because common access locks must be accessible by multiple tenant keys, and because valid tenant keys are often added and removed, the inventive system can automatically update the common access lock simply by recording updated information in new tenant keys 432 without requiring the operator to program the common access lock directly. Instead, when a new tenant key 432 is made, the operator may select via the user interface 108 of the system manager 106 which common access locks the tenant key 432 will be able to open. This data in stored in the common access lock enable field 422. p0 p. When the tenant key 432 is inserted in a given common access lock (block 700), the circuit 204 in the common access lock will first check the distributor code 408, customer code 410 and the function ID 412 in the key to verify that the key is a tenant key for the property being accessed (block 702). If not, the common access lock denies access (block 704).

q. The common access lock circuit 204 then checks the unit number 414 (in this case, the unit number) and the key ID 416 of the tenant key, which tells the circuit 204 which bit in the “tenant key inhibit data” field 424 stored in the lock memory 210 contains the bit corresponding to that particular tenant key 432 (block 706). If the tenant key inhibit data in the lock memory 210 indicates that the tenant key 432 has been inhibited (block 708), the common access lock will not open (block 704) and will not store any data from the key into the lock memory 210. Conversely, if the common access lock inhibit data stored in the lock memory 210 indicates that the inserted tenant key is active, the common access lock will open (block 710), compare the tenant key inhibit data on the tenant key with the corresponding inhibit data stored in the lock memory 210, and record the tenant key inhibit data on the key into the lock memory 210 (block 712).

r. Alternatively, the common access lock may be programmed using the utility device 111, particularly if multiple common access locks will be programmed at one time. To do this, common access lock data for the locks can be updated via the system manager 106 and downloaded from the system manager 106 to the utility device 111 via the key encoder 110. The updating process may include, for example, identifying all keys allowed to open the common access lock. The utility device 111 can then be taken to one or more common access locks, and the data in the utility device 111 can be uploaded to the common access lock. Because each common access lock has a unique identifier, the common access lock will be able to determine which data in the utility device 111 corresponds with a particular lock 104. Once the updated data is uploaded into the lock, the common access lock is ready to accept all valid keys identified through the system manager 106.

s. Although FIGS. 9 through 12 illustrate specific ways that the lock 104 can be programmed, one of ordinary skill in the art will understand that the general programming process (e.g., updating access codes, updating inhibit data) can be applied to any key type and is not limited to the examples shown in the Figures.

System Manager, Key Encoder and Utility Device

a. As noted above, the system manager 106 (FIG. 1) may be implemented as software in a personal computer. In one embodiment, the system manager 106 includes menus that allow a user to add, delete or modify employee data, add, delete or modify tenant data, customize the software to the housing facility's specific parameters (e.g., set room numbers, zone groupings, common access locks, etc.), program keys, read keys to log them back into the system or download stored data on the keys, upload data to and download data from the utility device, verify key contents, and print reports showing any combination of desired data (e.g., key histories, lock access history, employee report, activity reports, transaction reports, etc.) via the user interface 108. In one embodiment, the system manager 106 stores all of its information and activities to one or more databases 800. For protection, the system manager 106 may allow entry of usernames, passwords, and different levels of access to control that can create particular types of keys and print reports. The specific manner in which the system manager 106 carries out these functions is within the capabilities of one of ordinary skill in the art based on the security system parameters described above.

b. system manager. As shown in FIG. 1, the system 100 may include a key encoder 110 that acts as the interface between the keys 102 and the system manager 106 as well as the interface between a utility device 111 and the system manager 106.Generally,

c. FIG. 13 illustrates the key encoder 110 according to one embodiment of the invention. In one embodiment, the key encoder 110 includes a housing 850, a display 854 and a key slot 856 that can accommodate the circuit board 302 of the key 102. The key encoder 110 communicates with the system manager 106 via any known communication link (not shown). In one embodiment, the key encoder 110 is kept connected to the system manager 106 at all times.

d. Programming keys requires the key encoder 110 to be connected to the system manager 106 via any known communication link (not shown). To program a key 102, the system manager 106 first asks the user to select the type of key to be made. The specific information requested by the system manager 106 will correspond to the type of key being created. For a tenant key, for example, the user places the key into the key slot 856 of the key encoder 110 and input tenant and housing unit identification information into the system manager. In one embodiment, the operator inputs a valid housing unit number that the key will open (it is assumed that each tenant key will open the lock for only one unit number), tenant identification information (e.g., name) that can be used to track key usage via the audit trail, and any common access locks that the key should open.

e. Creating a limited use key, on the other hand, will require the system manager 106 to request additional information that will eventually be stored in the appropriate data fields specific to that key. For example, to create a limited use key for maintenance access, the system manager 106 will ask the operator to input a valid housing unit number, the duration that the key will work (e.g., 2 hours from the time the key is made), and a code corresponding to the reason the limited use key is being made. In one embodiment, it is assumed that the limited use key will be returned the same day that it is issued, after the maintenance request is fulfilled. The specific information and the manner in which the information is stored in the limited use key 600 is described above with respect to FIG. 6.

f. To log returned keys, the operator selects a key return function in the system manager 106 and inserts the key into the key slot 856, allowing the key encoder 110 to read the data from the key and send the read data to the system manager 106. The system manager 106 then displays the key's information, allowing the user to verify that the key being returned is the intended key. If not, the operator can notify the system manager that key in the key reader should not be returned and remove the key, leaving all of the data in the key intact and keeping the “active” status of the key in the system manager. If the operator wishes to continue with the key return transaction after verifying the key data, the system manager 106 logs the returned key information and erases the access data from the key 102. The erased key can then be reprogrammed and reused in the future.

Auditing a lock

a. The lock memory 210 in the lock 104 (FIG. 2) will store the following information each time a key 102 is inserted into the lock: (1) the time and date of the insertion; (2) the name/ID of the key and any related user identification data; (3) the type of key used; (4) the key's access code (date/time data).

b. When the audit trail is generated, the audit trail may also list the following information: (1) the last time the lock was powered up; (2) each time a utility device 110 is inserted into the lock 104; (3) each time a query key 500 is inserted in the lock 104.

c. The way in which auditing can be conducted using a query key 500 is explained above with respect to FIG. 5. Query keys are convenient because they can be made at any time and stored for later use. However, query keys are designed to retrieve the audit trail information from only one unit lock. The greater storage capacity of the utility device 111 allows the operator to download data from multiple locks (e.g., three unit locks, one common access lock, etc.). Once the query key 500 or the utility device 111 become completely filled with audit trail information, the information needs to be emptied to the system manager 106 to make room for more information.

d. FIG. 14 illustrates the utility device 111, which can be used for auditing multiple locks, according to one embodiment of the invention. The utility device 110 is a portable, stand-alone device that can be initialized by the system manager 106 via the key encoder 110 to have one or more selected functions, such as a time synchronizing device (to synchronize the locks 104 with the system manager 106), an audit trail retrieval device, and/or a common access lock programmer (to transfer an information database containing information for multiple tenants to a common access lock).

e. In one embodiment, the utility device 111 is a battery-operated device that contains a microprocessor (not shown) held in a housing 860 having an alpha-numeric display 862. The utility device 111 includes a plug 864 that can fit into the key slot 206 of the lock 104. The plug 864 can also fit into the key slot 856 of the key encoder 110 so that the utility device 111 can communicate with the system manager 106 through the key encoder 110, as noted above. The utility device 111 may also include a real-time clock chip and a back-up power supply (not shown) so that the utility device 111 will maintain correct date and time data as dictated by the system manager 106.

f. The utility device 111 preferably has a greater memory capacity than a query key 500 to allow it to hold audit trail data for multiple locks 104. Further, the utility device 111 can be updated with the current time, date, and/or key data from the system manager 106 and then taken to a lock 104 to update the internal clock 208 in the lock, as explained above. In short, the utility device 111 acts as the interface between the lock 104 and the system manager 106, communicating via the key encoder 110.

g. To download data from the lock memory 210 of a given lock using a utility device, the utility device 111 is first configured by the system manager 106 as an audit trail retrieval device taken to the lock(s) to be audited. Note that because the utility device 111 must be configured by the system manager 106 each time it to be used for lock auditing, it is somewhat less convenient to use than the query key 500.

h. The plug 860 of the utility device 110 is inserted into the key slot 206 of the lock 104 to be audited. If desired, the utility device 110 may be configured to display a message indicating that the download is taking place. When the audit trail data has been completely downloaded from the lock 104 into the utility device 110, another message may be displayed indicating that the download is complete.

i. If the operator wishes to download an audit trail from another lock 104, the operator can simply insert the plug 860 of the utility device 111 into another lock 104, without returning the utility device 111 to the system manager 106 to download the previous audit trail. Once all of the desired locks have been audited, the plug 864 of the utility device 111 is inserted back into the key slot of the key encoder 110 so that the system manager 106 can upload the audit trail stored in the device 111 for long-term storage, display and/or printing. Because the audit trail data includes lock identification data, the utility device 111 is able to track which audit trail corresponds to which lock 104.

j. As a result, the inventive system provides an access control system that provides a wide range of access options. The inventive system also can combine the key making and lock rekeying functions by automatically rekeying a lock when a newly-made key is inserted into the lock, eliminating the need to rekey the lock manually. Other advantages of the inventive system and its various components will be apparent to those skilled in the art.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. An electronic access control system, comprising:
a lock having a lock memory and a lock circuit in communication with the lock memory, wherein a lock access code and lock data is stored in the lock memory; and
an electronic key having a key access code and key data stored thereon, the electronic key adapted to communicate with the lock circuit,
wherein the lock circuit reprograms the lock memory if the key access code is greater than the lock access code.

2. The electronic access control system of claim 1, wherein the lock circuit denies entry if the key access code is less than the lock access code, allows entry if the key access code is equal to the lock access code, and allows entry and reprograms the lock memory by replacing the lock access code in the lock memory with the key access code if the key access code is greater than the lock access code.

3. The electronic access control system of claim 2, wherein the lock circuit also replaces at least a portion of the lock data in the lock memory with at least a portion of the key data if the key access code is greater than the lock access code.

4. The electronic access control system of claim 1, wherein the key access code and the lock access code are date/time stamps.

5. The electronic access control system of claim 1, wherein the lock further comprises an internal clock coupled to at least one of the lock memory and the lock circuit.

6. The electronic access control system of claim 1, wherein the lock and the electronic key each further comprise a wireless transceiver to allow contactless communication between the lock circuit and the electronic key.

7. The electronic access control system of claim 1, further comprising a switch configurable to act as at least one of a passage switch and a privacy switch.

8. The electronic access control system of claim 1, wherein the electronic key comprises:
a circuit board having at least one electrical contact adapted to communicate with the lock circuit;
a key memory that stores the key access data and the key data, wherein the key memory is coupled to said at least one electrical contact.

9. The electronic access control system of claim 1, wherein the key data is at least one selected from the group consisting of a distributor code, a customer code, a function ID, a unit number, a sequence number, a common access lock enable code, and an inhibit data array.

10. The electronic access control system of claim 9, wherein the lock circuit reprograms the lock memory if the key access code is greater than the lock access code by writing at least one of the key access code and the inhibit data array in the key memory into the lock memory.

11. The electronic access control system of claim 1, further comprising configuration key that configures the lock to accept at least one preselected key.

12. The electronic access control system of claim 1, wherein the lock memory stores audit trail data when the electronic key communicates with the lock.

13. The electronic access control system of claim 12, further comprising a query key that stores the audit trail data from the lock memory.

14. The electronic access control system of claim 1, wherein the electronic key is a limited use key that is operational for a limited time.

15. The electronic access control system of claim 1, wherein the electronic key is one selected from the group consisting of a programming key, a master key, a zone key, a tenant key, an inhibit master key, an inhibit zone key, and an inhibit tenant key.

16. The electronic access control system of claim 1, further comprising:
a system manager;
a key encoder in communication with the system manager; and
a utility device, wherein the key encoder acts as a communication interface between the electronic key and the system manager and between the utility device and the system manager.

17. The electronic access control system of claim 16, wherein the system manager is implemented via software in a personal computer.

18. The electronic access control system of claim 18, wherein the utility device is a stand-alone device comprising:
a power supply;
a memory; and
a plug that fits into the key encoder and the lock, wherein the plug allows data to be communicated between the utility device and the lock and between the utility device and the system manager via the key encoder.

19. An electronic key for an electronic access system, comprising:
a circuit board having at least one electrical contact adapted to communicate with a lock circuit;
a reprogrammable key memory that stores a key access code and key data, wherein the key memory is coupled to said at least one electrical contact and wherein the key access code is based on a date and time.

20. The electronic key of claim 19, wherein the key data is at least one selected from the group consisting of a distributor code, a customer code, a function ID, a unit number, a sequence number, a common access lock enable code, an inhibit data array, and audit trail data.

21. The electronic key of claim 20, wherein the function ID identifies the electronic key as a key type selected from the group consisting of a programming key, master key, zone key, tenant key, inhibit master key, inhibit zone key, inhibit tenant key, configure all key, configure passage key, configure unit key, query key, limited use key, maintenance key, and construction key.

22. The electronic key of claim 21, wherein said at least one electrical contact is formed on a first end the circuit board and wherein the electronic key further comprises a key bow formed on a second end portion of the circuit board.

23. The electronic key of claim 21, further comprising a wireless transceiver to allow wireless communication via the electronic key.

24. A method for controlling access in a property having a lock with a lock access code and lock data stored in a lock memory and an electronic key having a key access code and key data, the method comprising:
comparing the key access code with the lock access code;
denying entry if the key access code is less than the lock access code;
allowing entry if the key access code is equal to the lock access code; and allowing entry and reprogramming the lock by replacing the lock access code in the lock memory with the key access code if the key access code is greater than the lock access code.

25. The method of claim 24, wherein the reprogramming act further includes replacing at least a portion of the lock data in the lock memory with at least a portion of the key data if the key access code is greater than the lock access code.

26. The method of claim 24, wherein the key access code and the lock access code are date/time stamps.

27. The method of claim 24, further comprising storing the key data in the lock memory as an audit trail.

28. The method of claim 24, wherein the electronic key is a limited use key, and wherein the acts of allowing access and reprogramming the lock comprise:
checking whether a year, month and day portion in the key access code matches a date in an internal clock in the lock;
allowing access and replacing the lock access code with the key access code if the year, month and day portions of the key access code are equal, but a time portion of the key access code is smaller than a current time in the internal clock; and
allowing access if a time portion of the key access code is the same as or larger than the current time in the lock.

29. The method of claim 28, further comprising storing the key data in the lock memory and a key memory as an audit trail.

30. The method of claim 24, wherein the key data is at least one selected from the group consisting of a distributor code, a customer code, a function ID, a unit number, a sequence number, a common access lock enable code, and an inhibit data array.

31. The method of claim 30, wherein the reprogramming act reprograms the lock memory if the key access code is greater than the lock access code by writing at least one of the key access code and the inhibit data array in the key memory into the lock memory.
